(19) United States
(12) Patent Application Publication
(10) Pub. No.: US 2012/0117190 A1
(43) Pub. Date: May 10, 2012

(54) METHOD AND APPARATUS FOR PROVIDING SERVICE USING PERSONAL NETWORK

(75) Inventors: Sung-Jin PARK, Hwaseong-si (KR); Seok-Hoon Choi, Seoul (KR); Wuk Kim, Anyang-si (KR)

(73) Assignee: Samsung Electronics Co., Ltd., Suwon-si (KR)

(21) Appl. No.: 13/293,716

(22) Filed: Nov. 10, 2011

(30) Foreign Application Priority Data
Nov. 10, 2010 (KR) 10-2010-0111809
Jan. 7, 2011 (KR) 10-2011-0002000

(51) Int. Cl. G06F 15/16

(52) U.S. Cl. 709/217

(57) ABSTRACT

Disclosed is a method of providing a service of an external network through creating a service group including personal network devices establishing a personal network by a Converged Personal Network Service (CPNS) server. A plurality of service providers provide a service for each group without independent operation of the service group generation and management function, thereby conserving resources and improving efficiency.

### PRIORITY

This application claims priority under 35 U.S.C. §119(a) to Korean Patent Applications entitled “Method and Apparatus for Providing Service using Personal Network” filed in the Korean Industrial Property Office on Nov. 10, 2010 and Jan. 7, 2011 and assigned Serial Nos. 10-2010-0111809 and 10-2011-0002000, respectively, the contents of which are incorporated herein by reference.

### BACKGROUND OF THE INVENTION

1. Field of the Invention

The present invention relates generally to a personal network, and more particularly to a method and an apparatus for providing a service using a personal network.

2. Description of the Related Art

In view of the rapid increase in the use of Consumer Electronics (CE) devices capable of performing Short Range Communication (SRC), such as a Motion Pictures Experts Group (MPEG) Layer Audio 3 (MP3) player, a Portable Multimedia Player (PMP), a game player, and a netbook, users require a convenient method for downloading contents.

Generally, a user searches for contents reproducible in a CE device using a Personal Computer (PC) through the Internet and then downloads the searched contents. When the CE device is connected with the PC through an exclusive cable, the CE device downloads the contents from the PC. It had been essentially necessary to perform the aforementioned process so as to reproduce the corresponding contents in a CE device. Now, it is possible to share the contents between apparatuses using Bluetooth® instead of a cable.

However, there are a limited number of methods by which the CE device itself can directly access a telecommunication network. For example, some CE devices can access a telecommunication network only when they can use the Internet via Wireless Fidelity (Wi-Fi) in an area including an Access Point (AP). Accordingly, a necessity has emerged for a method by which an apparatus, i.e. a CE device, capable of performing SRC but incapable of directly accessing a telecommunication network can access a telecommunication network through a gateway, and use a desired service, such as contents downloading. To meet such a necessity, a Converged Personal Network Service (CPNS) has been disclosed.

The CPNS is a service in which a single Personal Network (PN) is configured with a device serving as a gateway for communication with a telecommunication network and a CE device actually using services and reproducing contents. The CE device accesses a service/content providing server existing in the telecommunication network through the device serving as the gateway to receive corresponding services or contents. The device serving as the gateway in the CPNS is referred to as a PN gateway and a CE device connected to the PN gateway through SRC to access a telecommunication network through the PN gateway is referred to as a Personal Network Entity (PNE).

For example, services provided through a PN includes various software services for upgrading each of the CE devices, video contents service, image contents service, audio contents services, and game services. Among these services, there is grouping a plurality of players into a group and providing contents in a group unit. For example, in a game service providing a board game, a plurality of players of the board game are grouped into a service group, and then the service is provided in a unit of the service group such that the players included in the service group play the board game together. A service provider providing a service in a group unit should have a service group generation and management function.

That is, each service provider providing a service in a group unit directly generates and manages a service group. For example, a relevant application should be installed in a user terminal so as to receive a game service from a service/content providing server providing a board game service. Then, when a user terminal makes a request for a service through an application, a service/content providing server groups another user terminal to play a board game together with the user terminal to generate a service group, and receives/transmits appropriate data for the progress of the board game to the user terminals included in the generated service group, to provide the board game service.

The service group generation and management function may be operated in a similar manner regardless of a type of provided services. For example, even though a first service provider provides a board game and a second service provider provides a baseball game, an algorithm of generating and managing a service group for the progress of each game may be formed in a similar manner.

However, each service provider establishes an independent service/content providing server, and each service/content providing server has a system for providing a service group generation and management function. Thus, although a plurality of service/content providing servers provides a service group generation and management function through a similar operator, the service/content providing servers must individually operate the service group generation and management function.

As such, the same function is inefficiently operated for each service, based on the repeated operation, and results in a waste of various resources.

### SUMMARY OF THE INVENTION

Accordingly, an aspect of the present invention is to solve the above—stated problems occurring in the prior art, and to provide a method and an apparatus for commonly providing a plurality of service providers with a function of generating and managing a service group necessary for providing a service by using a personal network.

An aspect of the present invention is to provide a method and an apparatus capable of preventing a waste of various resources used for the provision of a service.

In accordance with an aspect of the present invention, there is provided a method of providing a service of an external network through creation of a service group including personal network devices establishing a personal network by a CPNS server, the method including transmitting a service advertise message including information on one or more services provided from a service/content providing server existing in the external network to one or more personal network devices registered in the CPNS server, receiving a request for a specific service and a service group creation message requesting creation of a service group to share the specific service from a specific personal network device, transmitting an invite message for the service group to one or more member personal network devices included in the service group, creating the service group when an invite response message notifying of the acceptance of the invitation to the service group is received from the one or more member personal network devices, and transmitting service group inventory information including information on the generated service group to the service/content providing server.

### BRIEF DESCRIPTION OF THE DRAWINGS

The above and other aspects, features and advantages of the present invention will be more apparent from the following detailed description taken in conjunction with the accompanying drawings, in which:

FIG. 1 illustrates a CPNS system according to an embodiment of the present invention;

FIG. 2 illustrates a PNE according to an embodiment of the present invention;

FIG. 3 illustrates a PN gateway according to an embodiment of the present invention;

FIG. 4 illustrates a CPNS server according to an embodiment of the present invention;

FIG. 5 illustrates an operation of the CPNS server according to an embodiment of the present invention; and

FIG. 6 illustrates a message flow according to an embodiment of the present invention.

### DETAILED DESCRIPTION OF EMBODIMENTS OF THE PRESENT INVENTION

Hereinafter, the present invention will be described in detail with reference to the accompanying drawings. In the following description, the same elements will be designated by the same reference numerals although they are shown in different drawings. Further, a detailed explanation of known related functions and constitutions may be omitted for the sake of clarity and conciseness.

In the following description, for convenience's sake, the names of the entities defined in the CPNS of the Open Mobile Alliance (OMA), which is a standardization organization for applications of mobile terminals, will be used. However, such standards and names do not limit the scope of the present invention and may be applied to a system having a similar technical background.

According to the embodiments of the present invention, a CPNS server provides a service group generation and management function under the CPNS environment, so that a plurality of service providers may provide a service for each service group without necessity for independent operation of a group generation and management function.

The CPNS is for establishing a personal network between SRC devices and transferring a service provided from an external network through the personal network.

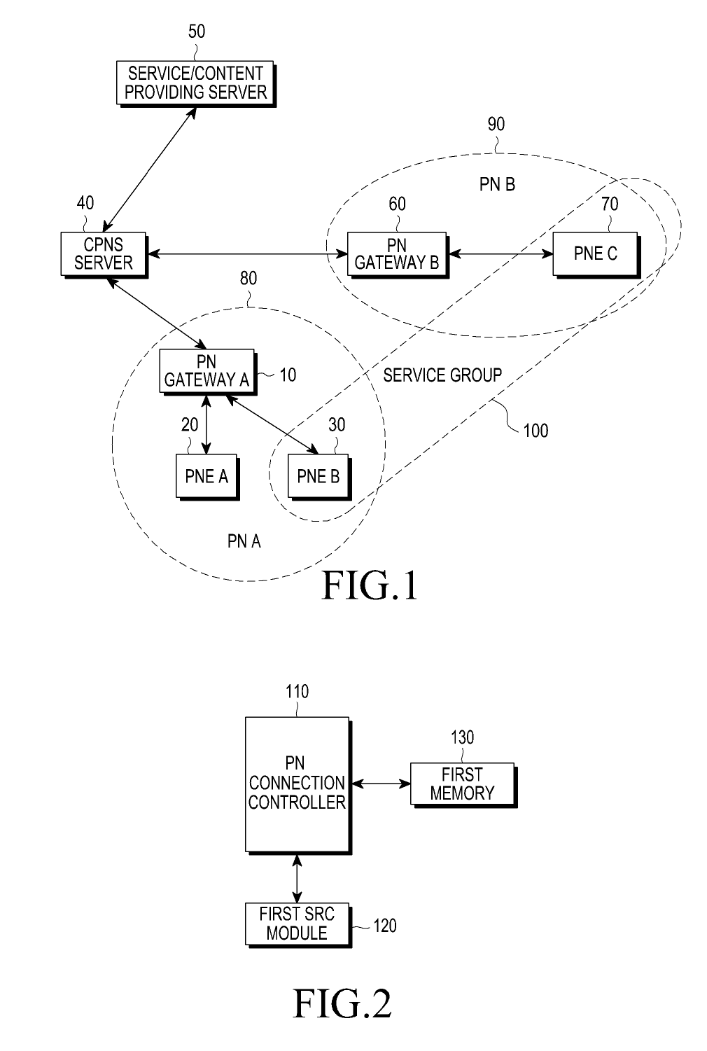

FIG. 1 illustrates a CPNS system according to an embodiment of the present invention. The CPNS system includes one or more Personal Network Entity (PNE) devices, PNE A 20, PNE B 30, PNE C 70, one or more PN gateways, PN gateway A 10 and PN gateway B 60, a CPNS server 40, and a plurality of service/content providing servers 50 serving as an application server.

The service/content providing server 50 exists in an external network and is an apparatus for providing a service or contents which a user can use through the CPNS server 40. Examples of the external network includes the Internet and a mobile phone operation network. When the service/content providing server 50 transmits, to the CPNS server 40, information on services or contents it provides, and when the service/content providing server 50 receives service group list information created by the CPNS server 40, the service/content providing server 50 provides a user terminal with its service or contents in accordance with a characteristic of a service group while utilizing the received service group inventory information.

PNE A 20, PNE B 30, and PNE C 70 are user terminal devices directly executing services. For example, these devices include an MP3 player, a PMP, and a mobile communication terminal. The user terminal devices reproduce contents stored therein, to provide a user with a service. PNE A 20, PNE B 30, and PNE C 70 have an SRC module and thus are capable of performing SRC with another surrounding device, i.e. another PNE or a PN gateway.

Such a PNE may be called a PN device. PNE A 20, PNE B 30, and PNE C 70 perform a paring with PN gateway A 10 and PN gateway B 60 through the SRC, to establish PN A 80. This establishment of the personal network involves checking whether the CPNS is supported between two devices, determining whether the two devices can use the CPNS through authentication/authorization, identifying roles between the devices, and establishing a network for providing the CPNS. Through the aforementioned PN A 80, PNE A 20, PNE B 30, and PNE C 70 may use a function of the CPNS server 40 capable of accessing an external network.

According to the embodiments of the present invention, PNE A 20, PNE B 30, and PNE C 70 receive a service advertise message and transmit a service group creation message including a service indication so as to share an interested service of a user with another user. When PNE A 20, PNE B 30, and PNE C 70 receive a service group invite message from the CPNS server 40, they transmit a service group invite response message containing a determination whether to join a service group, to the CPNS server 40. PNE B 30 and PNE C 70 insert an indicator notifying whether to install an application of a corresponding service in the service group creation message and the service group invite response message and transmit the service group creation message and the service group invite response message.

PN gateway A 10 and PN gateway B 60 are devices having a function capable of accessing the CPNS server 40 existing in an external network, i.e. an operator network. Further, PN gateway A 10 and PN gateway B 60 may establish a PN with PNE A 20 and PNE C 70, and serve to relay the transmission of a CPNS system message, a service, or contents between the CPNS server 40 and PNE 20 A and PNE C 70. That is, when PNE A 20 and PNE C 70 in the personal network make a request for a service, PN gateway A 10 and PN gateway B 60 relay and transfer the requested service to the CPNS server 40. PN gateway A 10 and PN gateway B 60 serve to transfer services or contents provided from the CPNS server 40 to PNE A 20 and PNE C 70. In addition, PN gateway A 10 and PN gateway B 60 connect their PNs to another PN to relay the transmission/reception the contents in a peer-to-peer scenario. An example of PN gateway A 10 and PN gateway B 60 includes a mobile phone, a Personal Data Assistant (PDA), and a set-top box.

The CPNS server 40 is a device for registering and managing PN gateway A 10 and PN gateway B 60, PNE A 20 and PNE C 70, and PN A 80 according to registration requests of PN gateway A 10 and PN gateway B 60, and processing a service or content request of PNE A 20 and PNE C 70 transmitted through PN gateway A 10 and PN gateway B 60. When the CPNS server 40 has the requested service or content, the CPNS server 40 provides PNE A 20 and PNE C 70 with the requested service or content through PN gateway A 10 and PN gateway B 60. However, when the CPNS server 40 does not have the requested service or content, the CPNS server 40 transmits the request of the service or content to the external service/content service provider 50 to prompt the external service/content service provider 50 to provide PNE B 30 and PNE C 70 with the corresponding service or content through PN gateway A 10 and PN gateway B 60.

The CPNS server 40 receives information on a service from the service/content providing server 50 and creates a service description, and guides the created service description to PNE A 20, PNE B 30, and PNE C 70 through the service advertise message. When PNE B 30 and PNE C 70 make a request for the creation of a service group while designating a specific service, the CPNS server 40 creates a service group and transmits a service group invite message to member PNEs invited by the PNE making the request for the creation of the service group. In this process, the CPNS server 40 determines whether an application of a corresponding service is installed for each PNE, and if the application is not installed, the CPNS server 40 installs the application. The CPNS server 40 stores information on the service group after creating the service group, notifies the service/content providing server 50 of the completion of the creation of the service group, and transmits information on the service group and makes a request for the service.

A service group may be created between the PNEs within a single PN or between the PNEs belonging to different PNs (see a service group region 100 of FIG. 1).

FIG. 2 illustrates the construction of PNE A 20 according to an embodiment of the present invention, but PNE B 30 and PNE C 70 may also be configured similar to PNE A 20. Referring to FIG. 2, PNE A 20 includes a PN connection controller 110, a first Short Range Communication (SRC) module 120, and a first memory 130.

The first SRC module 120 is for performing a short range communication, such as Bluetooth®, Zigbee®, Infrared Data Association (IrDA), or visible light communication.

The first memory 130 may be used as a working memory of the PN connection controller 110, and stores various program data necessary for the establishment of a PN and device information on PNE A 20. The first memory 130 stores service description contained in a service advertise message transmitted from the CPNS server 40 through the PN gateway 10. The service description contains a list of various services provided from the CPNS server 40, an indication of each service, information on applications necessary for the execution of each service, a brief explanation of each service, and information about whether a service group is necessary for each service. The first memory 130 stores information related to various service applications installed in PNE A 20.

The PN connection controller 110 controls all the operations of PNE A 20 related to establishment and release of a PN and operations related to the request for and the receipt of a service or content through the established PN. Accordingly, the PN connection controller 110 controls the first SRC module 120 so as to establish a personal network and performs a physical pairing with surrounding devices, to establish a communication link. The PN connection controller 110 searches for a PN gateway among the physically paired devices. When the PN gateway is found, the PN connection controller 110 makes a request for the connection of a personal network to the found PN gateway.

The PN connection controller 110 stores the service description contained in the service advertise message transmitted from the CPNS server 40 through the PN gateway 10 in the first memory 130, creates a specific service request and service group creation message in accordance with the request of a user, and transmits the created message to the CPNS server 40 through the PN gateway 10. The specific service request and service group creation message contains a service indication of a corresponding service and information on whether a relevant application is installed, and may contain an identifier of a member PNE to be grouped into a service group.

When the PN connection controller 110 receives a service group invite message for a specific service, the PN connection controller 110 notifies a user of the received service group invite message, creates a service group invite response message containing information on whether the user accepts the invitation to the specific service in accordance with a response input of the user, and transmits the created service group invite response message to the CPNS server 40 through the PN gateway 10. If the service group invite response message indicates that the user accepts the invitation to the service group, the response message contains information about whether a relevant application is installed.

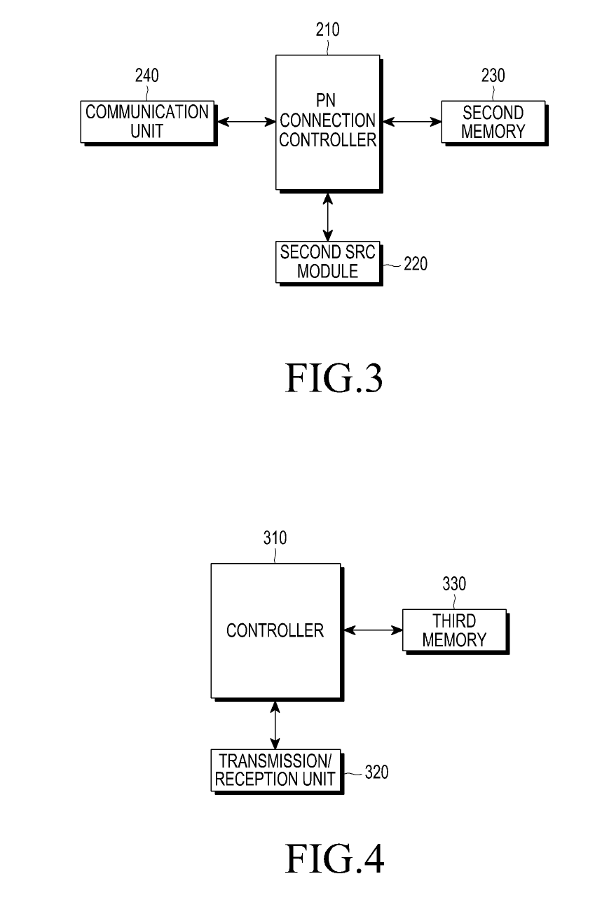

FIG. 3 illustrates the PN gateway A10 according to an embodiment of the present invention; however, PN gateway B 60 may be also configured similar to PN gateway A 10. Referring to FIG. 3, PN gateway A 10 includes a PN connection controller (or management unit) 210, a second RF communication module 220, a second memory 230, and a communication unit 240.

The second SRC module 220 is for performing a short range communication, such as Bluetooth®n, Zigbee®, IrDA, or visible light communication.

The communication unit 240 communicates with entities in an external network, and transmit/receives messages and data with the CPNS server 40 and the service/content providing server 50.

The second memory 230 may be used as a working memory of the PN management unit 210 and stores various program data necessary for the establishment of a PN. The second memory 230 stores a PNE list of PNEs connected to the PN and information on a device corresponding to each PNE. In this case, the PNE list and the device information may be classified for each corresponding personal network to be managed.

The PN management unit 210 controls a general operation of PN gateway A 10 related to a personal network. That is, the PN management unit 210 controls the second SRC module 220 so as to establish a personal network and performs a physical pairing with surrounding devices to establish a communication link. When the PN management unit 210 receives a mode search message from the physically paired device, the PN management unit 210 transmits a response message indicating the PN gateway to a corresponding device. When the PN management unit 210 receives a personal network connection request from the paired device, the PN management unit 210 authenticates and authorizes the corresponding device, allocates a PNE identifier to the corresponding device, and creates a new PNE list or updates an existing PNE list.

FIG. 4 illustrates the CPNS server 40 according to an embodiment of the present invention. Referring to FIG. 4, the CPNS server 40 includes a controller 310, a transmission/reception unit 320, and a third memory 330.

The transmission/reception unit 320 performs communication with a PN gateway and the service/content providing unit under the control of the controller 310.

The third memory 330 registers and stores a PNE list transmitted from the PN gateway A 10 and PN gateway B 60. The third memory 330 stores various contents and services to be provided to a PNE and a service matching table corresponding to each content and service. The service matching table is information about a minimum device function and capability required to a PNE which will receive and process a corresponding content or service.

The third memory 330 stores service information provided from the service/content providing server 50. The service information contains a list of various services provided from the service/content providing server 50, an identifier of each service, information on an application required for the execution of each service, brief description of each service, and information on whether a service group is necessary for each service. The third memory 330 stores applications corresponding to various services and service group inventory information about a service group created in correspondence to a specific service. The service group inventory information corresponding to each service group contains a type of service corresponding to a corresponding service group, an identifier of a corresponding service group, and an identifier of a grouped PNE.

The controller 310 controls a general operation of the CPNS server 40, authenticates and authorizes the PNE included in the PNE list to use the CPNS according to a PNE list registration request of PN gateway A 10 and PN gateway B 60, and stores the PNE list in the third memory 330. The controller 310 acquires device information of a corresponding PNE and personal network information on a personal network in which a corresponding PNE exists according to the service or content request of the PNE transmitted from PN gateway A 10 and PN gateway B 60. The controller 310 identifies whether the service or content requested by the PNE is available to the PNE by using the acquired device information and personal network information and adjusts the service or content in an available form to transmit the adjusted service or content to the corresponding PNE through PN gateway A 10 and PN gateway B 60.

Further, the controller 310 stores service information provided from the service/content providing server 50 in the third memory 330 and creates a service description with reference to the stored service description. The service description contains a list of various services provided from the service/content providing server 50, an identifier of each service, information on an application required for the execution of each service, a brief description of each service, and information on whether a service group is necessary for each service. The controller 310 creates a service advertise message containing the service description and transmits the created service advertise message to all the registered PNEs.

When the controller 310 receives a service group creation message requesting the creation of a service group with a designation of a specific service from a specific PNE, the controller 310 determines whether a relevant application is installed in the corresponding PNE. If the relevant application is not installed in the corresponding PNE, the controller 310 installs the relevant application. Then, the controller 310 creates a service group invite message to be transmitted to member PNEs invited through the service group creation message, which contains an identifier of a relevant service and information on whether it is necessary to install an application, and may additionally contain information on another PNE which is expected to join a corresponding service group. The controller 310 transmits the service group invite message to a corresponding PNE through the transmission/reception unit 320 and induces the corresponding PNE to join the service group.

In this process, the controller 310 determines whether an application of a corresponding service is installed in each PNE, and if the application of the corresponding service is not installed in each PNE, the controller 310 installs the application. Further, the controller 310 creates a service group including a PNE transmitting a service group invite response message in response to the service group invite message and the specific PNE and stores service group inventory information that is information on the service group in the third memory 330. The controller 310 notifies the service/content providing server 50 of the completion of the creation of the service group and transmits the service group inventory information to the service/content providing server 50.

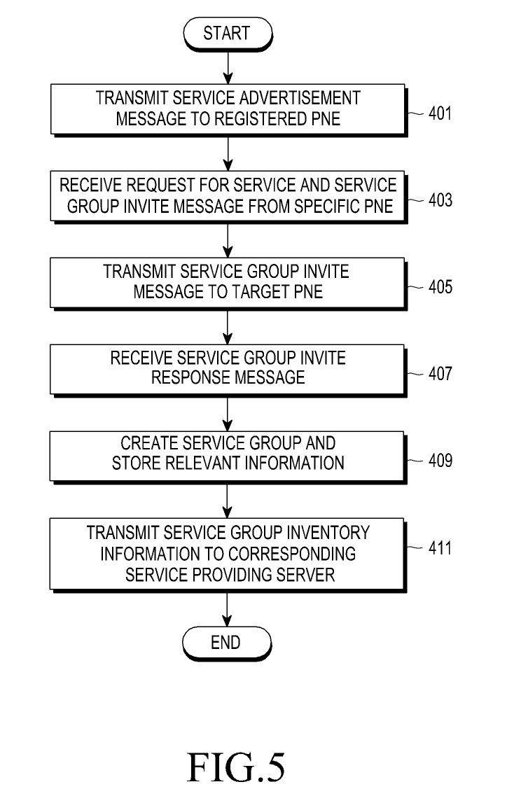

The process of an operation of the CPNS server 40 is illustrated in FIG. 5.

In step 401, the controller 310 transmits a service advertise message to a registered PNE. When the controller 310 receives a specific service request and service group creation message from a specific PNE in step 403, the controller transmits a service group invite message to a target PNE in step 405. When the controller 310 receives a service group invite response message notifying the acceptance of the service group invitation from the target PNE in step 407, the controller 310 creates a service group and stores relevant information in step 409. Then, the controller 310 transmits service group inventory information to a corresponding service providing server in step 411.

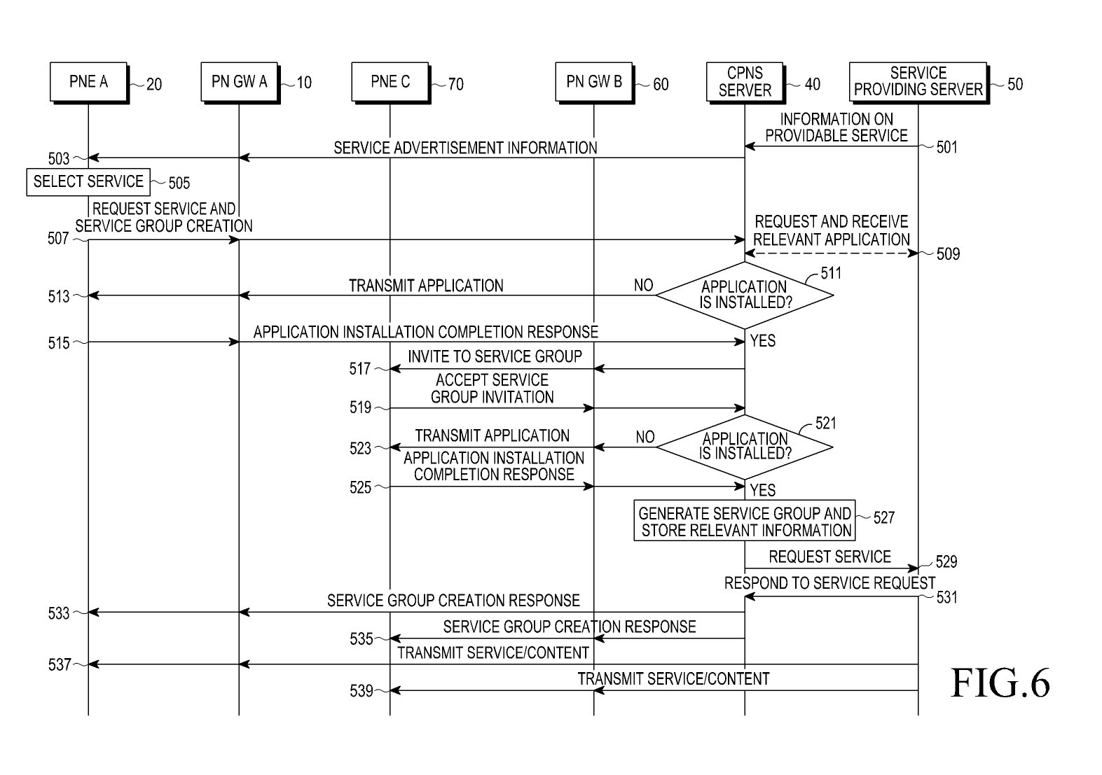

FIG. 6 illustrates an embodiment in which a request for the creation of a single service group including two PNEs, PNE A 20 and PNE C 70, and two PNA gateways, PN gateway A 10 and PN gateway B 60, is made to the CPNS server 40, the CPNS server 40 creates and manages a service group and transmits service group information to the service/content providing server 50, which provides the service group with a service by utilizing the service group information.

Referring to FIG. 6, the service/content providing server 50 transmits information on a providable service to the CPNS server 40 in step 501. The service information contains a service indication for discriminating services so that the service indication is used in the recognition and designation of a service to subsequently be used by a PNE. Further, the service indication for discriminating the services is used for a factor with which the CPNS server 40 creates a service group and then makes a request for a service to the service/content providing server 50. If an additional application is necessary for the use of a corresponding service, the service/content providing server 50 insets information on the necessity for the installation of the application in the service information to transmit the information to the CPNS server 40. The service/content providing server 50 may transmit a relevant application together with the service information.

The CPNS server 40 receiving the service information in step 501 creates and stores a service description, and then transmits the stored service description to a PNE registered in the CPNS server 40 through the service advertise message or to PNEs registered in the CPNS 40 through a PN gateway. The service description created by the CPNS server 40 contains a service indication and information regarding a necessity for the installation of an application. The CPNS server 40 transmits the service advertise message containing the service description to PNE A 20 through PN gateway A 10 in step 503. For the sake of simplicity, FIG. 6 illustrates that the CPNS server 40 transmits the service advertise message only to PNE A 20, but PNE B 70 also receives the service advertise message through PN gateway B 60.

PNE A 20 receiving the service advertise message displays the received service advertise message to provide the service description to a user. The user checks a service inventory contained in the service description and selects a specific service. For example, the service inventory may contain a board game, a baseball game, and a soccer game, and a user can select a game desired to be executed among those games.

The user may make a request for the creation of a service group in order to share a specific service. For example, the user makes a request for the creation of a service group so as to play a baseball game together with another PNE user. The user may designate another user to share a specific service, i.e. a member PNE to be grouped into a single service group. If the user desires to designate a PNE, the user may directly input identification information of a corresponding PNE or select a corresponding PNE in the PNE list displayed in PNE A 20. The PNE may be designated after the creation of the service group, and the addition of a PNE may be requested even after the creation of the service group.

PNE A 20 creates a specific service request and service group creation message corresponding to a specific service in accordance with an input of a selection of the user. The present embodiment describes when a user makes a request for a specific service, and makes a request for the creation of a service group for the specific service and designates a member PNE of the service group.

PNE A 20 creates the specific service request and service group creation message containing a service indication for the specific service selected by a user in step 505, information about whether an application related to the specific service is installed, and identifiers of member PNEs to share the specific service, and transmits the created specific service request and service group creation message to the CPNS server 40 through PN gateway A 10 in step 507.

The CPNS server 40 receiving the created specific service request and service group creation message from PNE A 20 identifies the service indication contained in the received message and determines whether the specific service additionally requires a specific application. If the specific application is required, the CPNS server 40 checks whether the specific application is installed in the PNE making a request for the service group creation through the service group creation message transmitted from the corresponding PNE in step 511. When the specific application is not installed in the corresponding PNE, the CPNS server 40 transmits the specific application to PNE A 20 through PN gateway A 10 in step 513. In this case, if the CPNS server 40 does not have the stored specific application, the CPNS server 40 may make a request for the specific application to the service/content providing server 50 and receive the specific application from the service/content providing server 50 in step 509.

PNE A 20 receiving the specific application from the CPNS server 40 in step 513 installs the received application. When the application is completely installed, PNE A 20 transmits an application installation completion message to the CPNS server 40 through PN gateway A 10 in step 515.

However, when the specific application has been already installed in PNE A 20 as a result of the identification in step 511, or when the CPNS server 40 receives the application installation completion message from PNE A 20 in step 515, the CPNS server 40 checks member PNE identifiers contained in the service group creation message received in step 507 and invites the member PNEs to the service group. At this time, the CPNS server 40 determines whether the member PNEs have been registered in the CPNS server 40. When the member PNEs have not been registered in the CPNS server 40, the CPNS server 40 notifies PNE A 20 that a corresponding member PNE cannot join the service group.

When the member PNEs have been registered in the CPNS server 40, the CPNS server 40 creates a service group invite message for inviting the member PNEs to the service group. The service group invite message contains the service indication for notifying the specific service for which the service group is created and information about the necessity for the installation of the specific application for the use of the specific service. The present embodiment describes when the PNE C 70 is designated as a member PNE by PNE A 10. Accordingly, the CPNS server 40 transmits the created service group invite message to PNE C 70 through PN gateway B 60 in step 517.

PNE C 70 receiving the service group invite message in step 517 displays a name of the service corresponding to the service indication contained in the service group invite message and contents indicating the service group invitation. A user of PNE C 70 inputs an acceptance or a rejection of the service group invitation and the PNE C 70 creates a service group invite response message, which contains information about the acceptance or rejection of the service group invitation and information about whether the specific application has been installed.

PNE C 70 transmits the service group invite response message to the CPNS server 40 through PN gateway B 60 in step 519. In this case, it is assumed that the service group invite response message contains information of the acceptance of the service group invitation. If the service group invite response message contains information of the rejection of the service group invitation, the CPNS server 40 notifies PNE A 20 of the failure of the service group creation.

The CPNS server 40 receiving the service group invite response message from PNE C 70 identifies information about whether the specific application has been installed in PNE C 70 contained in the received service group invite response message in step 521. When the specific application has not been installed in PNE C 70, the CPNS server 40 transmits the specific application to PNE C 70 through PN gateway B 60 in step 523.

PNE C 70 receiving the specific application from the CPNS server 40 in step 523 installs the received application. When the installation of the application is completed, PNE C 70 transmits the application installation completion message to the CPNS server 40 through PN gateway B 60 in step 525.

When PNE C 70 has already installed the specific application as a result of identification in step 521 or the CPNS server 40 receives the application installation completion message from PNE C 70 in step 525, the CPNS server 40 creates a service group including PNE A 20 and PNE C 70 and stores service group inventory information that is information about the service group in step 527. The service group inventory information contains a type of service corresponding to the specific service group, an identifier of the corresponding service group, and identifiers of the grouped PNEs. The CPNS server 40 receiving the service group invite response message from PNE C 70 identifies a service group identifier from the service group invite response message, notifies the service/content providing server 50 providing the specific service of the completion of the service group creation, transmits the service group inventory information, and makes a request for the specific service to the service/content providing server 50 in step 529.

The service/content providing server 50 transmits the service group inventory information and a service request response message to the CPNS server 40 in step 531.

The CPNS server 40 receiving the service group inventory information transmits information of the completion of the service group creation to PNE A 10 and PNE C 70 through PN gateway A 10 and PN gateway B 60 in steps 533 and 535. After the service/content providing server 50 receives the specific service request from the CPNS server 40 in step 529, the service/content providing server 50 begins to provide the service/contents to the member PNEs contained in the received service group inventory information in steps 537 and 539.

According to the present invention, the CPNS server provides a service group generation and management function under the CPNS environment, so that a plurality of service providers can provide a service for each group without independent operation of the service group generation and management function. Accordingly, the present invention reduces the inefficiency of repeated development and operation and waste of resources. Further, the CPNS server leads the installation of the application in a user terminal, thereby reducing a load of the service/content providing server.

While embodiments of the foregoing description of the present invention have been provided, various modifications are possible without departing from the scope of the present invention. For example, if a member PNE is not included in the service group creation message, the CPNS server 40 first creates a service group and then PNE A 20 may subsequently invite and add another member PNE to the service group. A process of addition of a designated member by a PNE in accordance with a member invitation is similar to that of FIG. 6. Alternatively, if a member PNE is not included in the service group creation message, the CPNS server 40 may randomly select one or more PNEs among the currently registered PNEs and create the service group.

While the present invention has been described in detail, the description of the present invention is merely an example and the present invention is not limited thereto. It will be understood by those skilled in the art that various changes in form and details may be made therein without departing from the spirit and scope of the invention as defined by the appended claims.

What is claimed is:

1. A method of providing a service of an external network through creating a service group including personal network devices establishing a personal network by a Converged Personal Network Service (CPNS) server, the method comprising:
transmitting a service advertise message including information on one or more services provided from a service/content providing server existing in the external network to one or more personal network devices registered in the CPNS server;
receiving a request for a specific service and a service group creation message for creating a service group to share the specific service from a specific personal network device;
transmitting an invite message for the service group to one or more member personal network devices included in the service group;
creating the service group; and
transmitting service group inventory information including information on the generated service group to the service/content providing server.

2. The method as claimed in claim 1, wherein the service group is created, when an invite response message notifying of the acceptance of the invitation to the service group is received from the one or more member personal network devices.

3. The method as claimed in claim 1, wherein the service advertise message further includes a service indication corresponding to each of the one or more services and information on each application related to the one or more services,
wherein the invite message includes a service indication corresponding to the specific service and information about whether it is necessary to install a specific application related to the specific service, and
wherein the service group inventory information further includes the service indication corresponding to the specific service, an identifier corresponding to the service group, and an identifier corresponding to a personal network device included in the service group.

4. The method as claimed in claim 1, wherein the service group creation message and the invite response message include a service indication corresponding to the specific service and information about whether a specific application related to the specific service is installed, and
the method further comprises transmitting the specific application to the specific personal network device and the member personal network device when the specific application is not installed in the specific personal network device and the member personal network device.

5. The method as claimed in claim 4, wherein the service group creation message further includes an identifier of the one or more member personal network devices.

6. The method as claimed in claim 2, wherein the one or more member personal network devices are randomly selected among one or more personal network devices registered in the CPNS server.

7. A Converged Personal Network Service (CPNS) server for creating a service group including personal network devices establishing a personal network to provide a service of an external network, the CPNS server comprising:
a memory for storing information on one or more personal network devices registered in the CPNS server and information on one or more services provided from a service/content providing server existing in the external network; and
a controller for transmitting a service advertise message including information on the one or more services to the one or more personal network devices, receiving a request for a specific service and a service group creation message for creating of a service group to share the specific service from a specific personal network device, transmitting an invite message for invitation to the service group to one or more member personal network devices included in the service group, creating the service group, and transmitting service group inventory information including information on the generated service group to the service/content providing server.

8. The CPNS server as claimed in claim 7, wherein the controller creates the service group, when an invite response message notifying acceptance of the invitation to the service group is received from the one or more member personal network devices.

9. The CPNS server as claimed in claim 8, wherein the service advertise message further includes a service indication corresponding to each of the one or more services and information on each application related to the one or more services,
wherein the invite message includes a service indication corresponding to the specific service and information about whether it is necessary to install a specific application related to the specific service, and
wherein the service group inventory information further includes the service indication corresponding to the specific service, an identifier corresponding to the service group, and an identifier corresponding to a personal network device included in the service group.

10. The CPNS server as claimed in claim 8, wherein the service group creation message and the invite response message include a service indication corresponding to the specific service and information about whether a specific application related to the specific service has been installed, and
wherein the controller transmits the specific application to the specific personal network device and the member personal network device when the specific application is not installed in the specific personal network device and the member personal network device.

11. The CPNS server as claimed in claim 10, wherein the service group creation message further includes an identifier of the one or more member personal network devices.

12. A method of receiving a service of an external network through a personal network by a personal network device establishing a personal network, the method comprising:
receiving a service advertise message including information on one or more services provided from a service/content providing server existing in the external network from a Converged Personal Network Service (CPNS) server;
transmitting a request for a first service among the one or more services and a service group creation message designating a member personal network device which will share the first service to the CPNS server;
receiving a creation response message indicating that the CPNS server completes the creation of the service group from the CPNS server; and
receiving the first service.

13. The method as claimed in claim 12, further comprising:
receiving a service group invite message for invitation to a specific service group created by the CPNS server for a second service in accordance with a request of a specific personal network device from the CPNS server; and
transmitting an invite response message indicating acceptance or rejection of the invitation to the specific service group to the CPNS server, and
wherein the service group creation message includes a service indication corresponding to the first service, information about whether a specific application related to the first service has been installed, and an identifier of the member personal network device.

14. The method as claimed in claim 12, wherein the service advertise message further includes a service indication corresponding to each of the one or more services and information on each application related to the one or more services.

15. A personal network device for establishing a personal network and receiving a service of an external network through the personal network, the personal network device comprising:
a Short Range Communication (SRC) module for performing communication for a personal network;
a memory for storing information on one or more services, which are provided from a service/content providing server existing in the external network, received from the Converged Personal Network Service (CPNS) server; and
a controller for receiving a service advertise message including information on the one or more services, transmitting a request for a first service among the one or more services and a service group creation message designating a member personal network device which will share the first service to the CPNS server, and receiving a creation response message indicating that the CPNS server completes the creation of the service group to the CPNS server.

16. The personal network device as claimed in claim 15, wherein the controller receives an invite message for invitation to a specific service group created by the CPNS server for a second service in accordance with a request of a specific personal network device, and transmits an invite response message indicating acceptance or rejection of the invitation to the specific service group to the CPNS server, and
wherein the service group creation message includes a service indication corresponding to the first service, information about whether a specific application related to the first service is installed, and an identifier of the member personal network device.

17. The personal network device as claimed in claim 15, wherein the service advertise message includes a service indication corresponding to each of the one or more services and information on each application related to the one or more services.

18. A Converged Personal Network Service (CPNS) system for providing a service of an external network through creating a service group including personal network devices establishing a personal network, the CPNS system comprising:
a service/content providing server for existing in the external network, providing one or more services, and providing a specific service among the one or more services to personal network devices included in a service group inventory information,
a CPNS server for transmitting a service advertise message including information on the one or more services one or more personal network devices registered in the CPNS server, receiving a request for the specific service and a service group creation message for creating a service group to share the specific service from a specific personal network device, transmitting an invite message for the service group to one or more member personal network devices included in the service group, creating the service group when an invite response message is received from the one or more member personal network devices and transmitting the service group inventory information including information on the generated service group to the service/content providing server,
the specific personal network device for receiving the service advertise message, transmitting the request for the specific service and the service group creation message designating the one or more member personal network devices which will share the specific service to the CPNS server, and receiving the specific service, and
the one or more member personal network devices for receiving the invite message and transmitting the invite response message notifying of the acceptance of the invitation to the service group.

19. The CPNS system as claimed in claim 18, wherein the service group creation message and the invite response message include a service indication corresponding to the specific service and information about whether a specific application related to the specific service has been installed.

20. The CPNS system as claimed in claim 18, wherein the CPNS server transmits the specific application to the specific personal network device and the one or more member personal network devices when the specific application is not installed in the specific personal network device and the one or more member personal network device.
